(19) United States
(12) Patent Application Publication
(10) Pub. No.: US 2014/0197563 A1
(43) Pub. Date: Jul. 17, 2014

(54) CARBON DIOXIDE SEQUESTRATION IN CONCRETE ARTICLES

(71) Applicants: Robert Niven, Ketch Harbour (CA); George Sean Monkman, Montreal (CA); Dean Forgeron, White's Lake (CA)

(72) Inventors: Robert Niven, Ketch Harbour (CA); George Sean Monkman, Montreal (CA); Dean Forgeron, White's Lake (CA)

(21) Appl. No.: 13/994,681

(22) PCT Filed: Dec. 15, 2011
(86) PCT No.: PCT/CA2011/050774

§ 371 Date: Nov. 1, 2013

Related U.S. Application Data
(60) Provisional application No. 61/423,354, filed on Dec. 15, 2010.

(51) Int. Cl. B28B 1/08; B28B 11/24

(52) U.S. Cl. CPC B28B 1/08; B28B 11/245
USPC 264/69; 264/85; 425/445; 425/424

(57) ABSTRACT

Concrete articles, including blocks, substantially planar products (such as pavers) and hollow products (such as hollow pipes), are formed in a mold while carbon dioxide is injected into the concrete in the mold, through perforations.

### CROSS REFERENCE TO RELATED APPLICATION

This application claims priority to U.S. Provisional Application No. 61/423,354 filed on Dec. 15, 2010, the entire contents of which are hereby incorporated herein by reference.

### FIELD

The present disclosure relates to processes and apparatuses for making concrete articles, for reducing the greenhouse gas emissions associated with making concrete articles, and for sequestering carbon dioxide.

### BACKGROUND

The following paragraphs are not an admission that anything discussed in them is prior art or part of the knowledge of persons skilled in the art.

U.S. Pat. No. 4,117,060 (Murray) describes a method and apparatus for the manufacture of products of concrete or like construction, in which a mixture of calcareous cementitious binder substance, such as cement, an aggregate, a vinyl acetate-dibutyl maleate copolymer, and an amount of water sufficient to make a relatively dry mix is compressed into the desired configuration in a mold, and with the mixture being exposed to carbon dioxide gas in the mold, prior to the compression taking place, such that the carbon dioxide gas reacts with the ingredients to provide a hardened product in an accelerated state of cure having excellent physical properties.

U.S. Pat. No. 4,362,679 (Malinowski) describes a method of casting different types of concrete products without the need of using a curing chamber or an autoclave subsequent to mixing. The concrete is casted and externally and/or internally subjected to a vacuum treatment to have it de-watered and compacted. Then carbon-dioxide gas is supplied to the mass while maintaining a sub- or under-pressure in a manner such that the gas diffuses into the capillaries formed in the concrete mass, to quickly harden the mass.

U.S. Pat. No. 5,935,317 (Soroushian et al.) describes a CO₂ pre-curing period used prior to accelerated (steam or high-pressure steam) curing of cement and concrete products in order to: prepare the products to withstand the high temperature and vapor pressure in the accelerated curing environment without microcracking and damage; and incorporate the advantages of carbonation reactions in terms of dimensional stability, chemical stability, increased strength and hardness, and improved abrasion resistance into cement and concrete products without substantially modifying the conventional procedures of accelerated curing.

U.S. Pat. No. 7,390,444 (Ramme et al.) describes a process for sequestering carbon dioxide from the flue gas emitted from a combustion chamber. In the process, a foam including a foaming agent and the flue gas is formed, and the foam is added to a mixture including a cementitious material (e.g., fly ash) and water to form a foamed mixture. Thereafter, the foamed mixture is allowed to set, preferably to a controlled low-strength material having a compressive strength of 1200 psi or less. The carbon dioxide in the flue gas and waste heat reacts with hydration products in the controlled low-strength material to increase strength. In this process, the carbon dioxide is sequestered. The CLSM can be crushed or pelletized to form a lightweight aggregate with properties similar to the naturally occurring mineral, pumice.

### SUMMARY

The following summary is intended to introduce the reader to the more detailed description that follows and not to define or limit the claimed subject matter.

In an aspect of the present disclosure, a process for forming concrete blocks may include: providing a concrete block molding machine; providing a mold in conjunction with the block molding machine, the mold including a core assembly having a plurality of perforations distributed across at least one core form of the core assembly; and injecting carbon dioxide into concrete in the mold through the perforations.

The carbon dioxide may be injected at least in part while the mold is shaken. The carbon dioxide may be injected for a period of time of about 60 seconds or less, or for a period of time of about 30 seconds or less, or for a period of time of about 10 seconds or less. The carbon dioxide may be injected at an applied pressure of about 350 kPa above atmospheric pressure or less.

The process may further include curing formed concrete blocks at a temperature between about 35 and 70° C. and relative humidity of about 75% or more.

The process may further include providing the carbon dioxide in a gas that includes at least about 90% carbon dioxide. The gas may be derived from a pressurized gas source. The gas may be heated. The gas may include a flue gas. The flue gas may be derived from a steam or heat curing process for blocks formed by the concrete block molding machine.

The process may further include injecting the gas at a rate of about 80 litres per minute per litre of the concrete or less.

In an aspect of the present disclosure, an apparatus for forming concrete blocks may include: a mold shaped to form one or more surfaces of a concrete block; a molding machine adapted to shake the mold while it is full of concrete; a core assembly of the mold, the core assembly including at least one core form having a plurality of perforations through a molding surface of the core form, and a core bar attached to the core form including a conduit for gas to flow from an inlet to an interior of the core form; and a gas injection system adapted to inject carbon dioxide into the concrete in the mold through the perforations while the concrete is in the mold.

The perforations may be distributed generally uniformly across most of the molding surface of the core form. Adjacent perforations may be spaced at about 5 cm or less apart from each other. The conduit may be located within the core bar. The core form may include a vacuum breaker. A wall may separate the vacuum breaker from the interior of the core form. The core form may include a bottom wall or gasket so that a generally sealed space is defined in the core form between the inlet and the perforations, at least when the core form is resting on a tray.

The gas injection system may be adapted to inject carbon dioxide into concrete in the mold through the core form while the concrete is being shaken in the mold. The gas injection system may include at least one of a gas inlet manifold and a mass flow meter for delivering the carbon dioxide to the core assembly. The apparatus may include a system for injecting a compressed gas through the perforations while concrete is not in the mold.

Each of the perforations may include a hole having a diameter of between about 1 mm and 3 mm. The holes may be generally conical in shape, having a diameter at the mold surface that is greater than a diameter at the interior of the core form. The holes may be declined pointing downwardly into the concrete at an angle relative to horizontal.

In an aspect of the present disclosure, a process may include: providing a molding machine adapted to form a concrete article; providing a mold within the molding machine, the mold including a plurality of perforations distributed across at least one molding surface; and injecting carbon dioxide into concrete in the mold through the perforations.

The concrete article may be a substantially planar product, and the step of injecting may include flowing the carbon dioxide downwardly through the perforations into the concrete. The step of injecting may include flowing the carbon dioxide through at least one shoe element.

The concrete article may be a hollow product, and the step of injecting may include flowing the carbon dioxide radially outwardly through the perforations into the concrete. The step of injecting may include flowing the carbon dioxide through an inner mold wall.

In an aspect of the present disclosure, an apparatus may include: a mold shaped to form one or more surfaces of a concrete article, the mold including at least one molding surface including a plurality of perforations; a conduit for gas to flow from an inlet to each of the perforations; and a gas injection system adapted to inject carbon dioxide into concrete in the mold through the perforations while the concrete is in the mold.

The concrete article may be a substantially planar product, and the mold may include a base plate, a plurality of plates extending upwardly from the base plate, and a shoe element adapted to descend vertically into the mold to compact the concrete. The perforations may be formed in the shoe element so that the carbon dioxide flows downwardly into the concrete.

The concrete article may be a hollow product, and the mold may include inner and outer mold walls being generally cylindrical and generally concentrically arranged. The perforations may be formed in the inner mold wall so that the carbon dioxide flows radially outwardly into the concrete.

In an aspect of the present disclosure, a process may include injecting carbon dioxide into concrete, including while the concrete is being shaken or vibrated in a mold, through a porous component of the mold for a period of time of about 60 seconds or less at a pressure of about 350 kPa above atmospheric pressure or less.

In an aspect of the present disclosure, a process of accelerating the curing of concrete while of sequestering carbon dioxide in the concrete may include: preparing the concrete including at least aggregate, a cementitious material, and water; and injecting a stream of carbon dioxide-containing gas under pressure into a subsurface volume of the concrete at a plurality of locations adjoining the concrete.

The step of injecting may include injecting the carbon dioxide-containing gas through a plurality of apertures at the respective locations. The step of preparing may include disposing the concrete in contact with the apertures. The process may further include shaking the concrete while the stream of the carbon dioxide-containing gas is being injected into the subsurface volume. The carbon dioxide-containing gas may be injected at a rate of about 80 litres per minute per litre of the concrete or less.

Other aspects and features of the teachings disclosed herein will become apparent, to those ordinarily skilled in the art, upon review of the following description of the specific examples of the specification.

### DRAWINGS

The drawings included herewith are for illustrating various examples of processes and apparatuses of the present specification and are not intended to limit the scope of what is taught in any way. In the drawings:

FIG. 1 is a flow chart describing a concrete block manufacturing process;

FIG. 2 shows a concrete block molding machine;

FIG. 3A is a perspective view of a core assembly adapted to inject carbon dioxide;

FIG. 3B is a cross section of the core assembly of FIG. 3A;

FIG. 4A is a perspective view of another core assembly adapted to inject carbon dioxide;

FIG. 4B is a cross section of the core assembly of FIG. 4A;

FIGS. 5A, 5B and 5C are schematic drawings of carbon dioxide injection apparatuses;

FIG. 6 is a flow chart describing a concrete block manufacturing process with carbon dioxide injection;

FIG. 7 is a cross section of a mold assembly adapted to manufacture concrete articles using carbon dioxide injection; and

FIG. 8 is a cross section of another mold assembly adapted to manufacture concrete articles with carbon dioxide injection.

### DETAILED DESCRIPTION

Various apparatuses or processes will be described below to provide an example of an embodiment of each claimed invention. No embodiment described below limits any claimed invention and any claimed invention may cover processes or apparatuses that are not described below. The claimed inventions are not limited to apparatuses or processes having all of the features of any one apparatus or process described below or to features common to multiple or all of the apparatuses described below. It is possible that an apparatus or process described below is not an embodiment of any claimed invention. Any invention disclosed in an apparatus or process described below that is not claimed in this document may be the subject matter of another protective instrument, for example, a continuing patent application, and the applicants, inventors or owners do not intend to abandon, disclaim or dedicate to the public any such invention by its disclosure in this document.

For simplicity and clarity of illustration, where considered appropriate, reference numerals may be repeated among the drawings to indicate corresponding or analogous elements or steps.

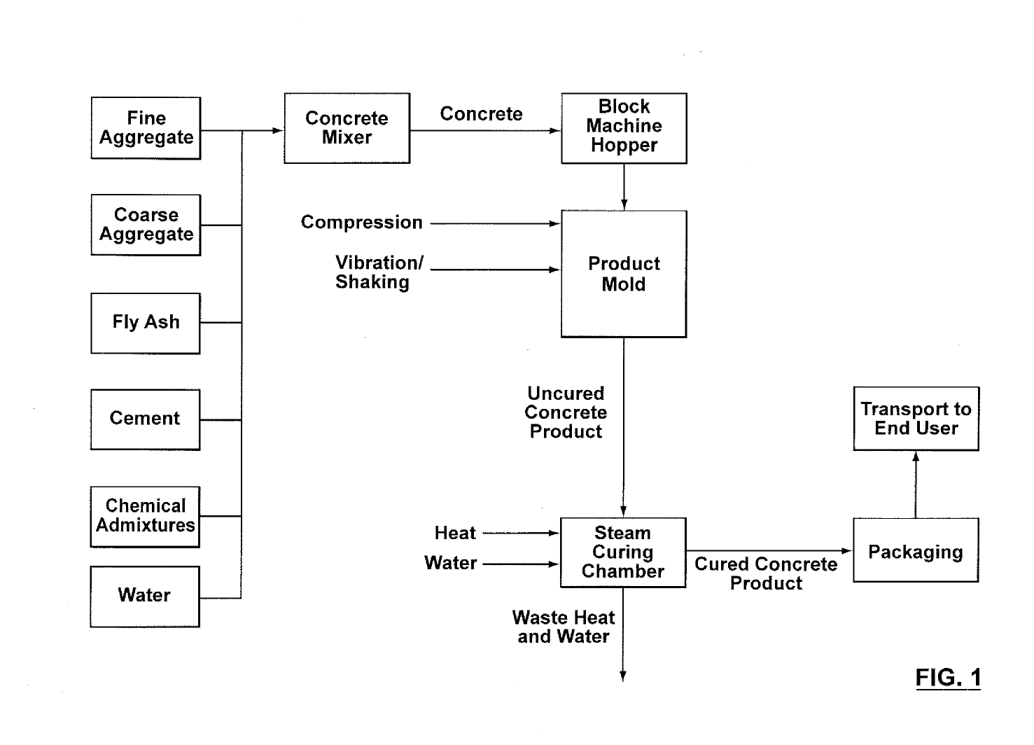

Referring to FIG. 1, concrete blocks are made commercially by forming them in a molding machine and then, curing the formed blocks. In a typical plant, various ingredients are conveyed to a mixer to make concrete. The ingredients may be, for example, fine aggregate, coarse aggregate, fly ash, cement, chemical admixtures, and water. The mixed concrete is transferred to a hopper located over a molding machine. In each production cycle, an appropriate volume of concrete passes from the hopper to the molding machine. The concrete is formed and compacted (shaken and compressed) in the molding machine into a plurality of blocks, typically four or more. The blocks leave the molding machine on a tray, which is conveyed to a curing area. The blocks may be cured slowly (7 to 30 days) by exposure to the atmosphere. However, in most commercial operations the blocks are cured rapidly by steam or heat curing. For example, blocks may be placed in a steam-curing chamber for 8 to 24 hours, where it is maintained at a temperature between about 35 and 70° C. and relative humidity of about 75% or more. The cured blocks are removed from the curing area and sent to further processing stations for packaging and transport to the end user.

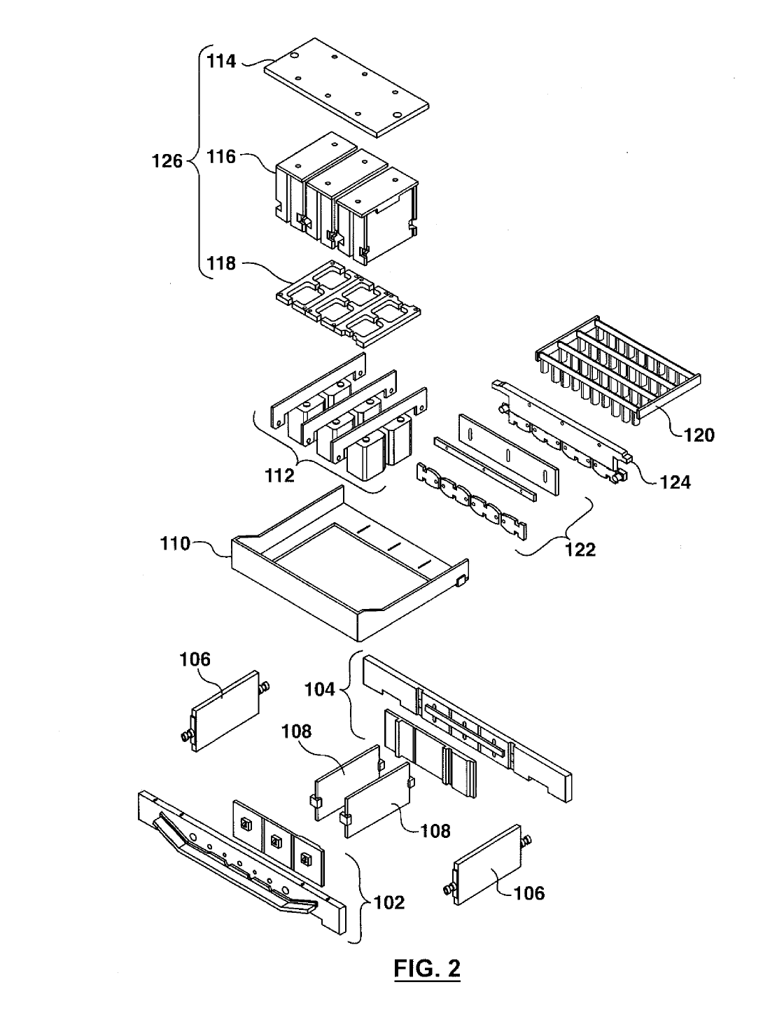

A molding machine may be designed to accept a variety of mold forms or shells depending on the concrete articles to be produced. For example, referring now to FIG. 2, for standard dual cavity wall construction blocks, the outer size and shape of the blocks is created by a front and back bar 102, 104, a pair of side bars 106, and division plates 108 extending between the front and back bar 102, 104. These components create a set of cavities, one for each of the blocks to be produced, that are open at the top and bottom of each cavity. A mold top plate 110 is added onto these components but does not close the openings at the top of the cavities. Core assemblies 112 are bolted to the top plate 110. Each core assembly 112 includes two core-forming dies or forms suspended from a mounting bar, optionally called a core bar. The core-forming dies determine the size and shape of the cavities in the finished block.

The mold and a stripper assembly 126 connected to a compaction arm (not shown) are the two main movable parts in the molding machine. Both components may vibrate during production to promote compaction of the concrete. The stripper assembly 126, made up of a base plate 114, stripper head sections 116, and stripper shoes 118, also presses on the upper surfaces of the block as it is being formed to further enhance compaction. The compaction allows concrete mixes with low water content and low slump to be used.

The molding machine may further include various ancillary components. For example, an agitator grid 120 may be inserted into the mold cavities to vibrate the concrete. Cut-off blades 122, notched to clear the mounting bars of the core assemblies 112, are attached to a cut off bar 124 and used to scrape excess concrete from the top of the mold.

The production cycle involves several steps performed in a very short period of time in the molding machine. The process starts with a tray being inserted into the molding machine. The mold form is lowered on to the tray. The form is filled with concrete from the hopper, possibly while being vibrated. The cut off blades are pulled across the form to remove excess concrete. The stripper assembly is lowered on the compaction arm to compact the filled form while the stripper assembly and mold form are shaken. The form is raised while the stripper assembly is still in its lowered position leaving the shaped concrete blocks on the tray. The compaction arm is then raised, allowing the formed blocks to be ejected from the molding machine on the tray. The cycle is then repeated while the tray of formed blocks travels on a conveyor to the steam chamber.

Each production cycle may make only a small number of blocks, for example 1 to 16 or more, but lasts for only a very short period of time, for example about 5 to 10 seconds. In this way, many blocks may be made in a working shift and transferred to an accelerated curing chamber. Accelerated curing is routinely used to make the blocks stable quickly and thereby reduce the total production time until the blocks may be shipped as finished product.

Accelerated curing typically involves placing the formed blocks in an enclosure and controlling the relative humidity and heat in the chamber for several hours. In cold climates, steam is commonly used. When the ambient temperature is adequate, moisture may be added without additional heat. The blocks usually sit in the curing chamber for 8-48 hours before they are cured sufficiently for packaging.

The block manufacturing process described above is energy intensive. Energy required for the steam curing typically exceeds 300 MJ per tonne of blocks. Depending on the source of this energy, the greenhouse gas emissions associated with steam curing may be significant, up to about 10 kg of CO₂ per tonne of block. While most blocks are well formed, in a typical production shift several blocks are damaged as they are stripped from the form and have to be discarded.

In an apparatus described herein, a standard concrete block mold form is fitted with a new or modified core assembly. The wall surfaces of the core forms are perforated with a plurality of small holes or perforations. Conduits are provided in or along the core bar from an inlet at the front of the core bar to the insides of the core forms. A sheath is provided around a vacuum breaker, if any. With these features, the modified core assembly is adapted to receive carbon dioxide fed to the inlet and to inject that carbon dioxide into the concrete in the mold. However, no other parts of the molding machine may need to be changed. Since the core assembly is a consumable part of the mold, new core assemblies as described herein may be provided at a minimal incremental cost as old core assemblies wear out. Alternatively, existing core assemblies may be modified. The inlets of the core assemblies are attached to a source of carbon dioxide so that carbon dioxide may be injected into the concrete, preferably during the filling and compaction stages. Modifications to the core bar to allow for gas transmission into the concrete are completed so that they do not interfere with the motion of the cut-off blades.

In a process described herein, a pressurized flow of gas containing carbon dioxide is injected into concrete through one or more mold elements. The gas enters the concrete mix while the molds are vibrated or shaken. Optionally, the flow of gas may begin while the mold is being filled, and may continue until the mold is stripped. Optionally, stripping the mold may be delayed to allow for a longer period of carbon dioxide injection.

While using the new or modified core assemblies described herein, the production cycle remains generally unchanged. However, carbon dioxide is injected into the concrete through the core assemblies or other mold components. The addition of carbon dioxide, rather than moisture or heat alone during accelerated curing, promotes an alternate set of chemical reactions resulting in different reaction products. In particular, more thermodynamically stable calcium carbonate (limestone) solids are formed preferentially to calcium hydroxide (portlandite) products. The carbon dioxide is dissociated in water in the concrete to produce carbonate ions. These ions combine with calcium ions in the cement to precipitate calcium carbonate in addition to amorphous calcium silicates that provide early dimensional stability in the concrete blocks. In this way, carbon dioxide is sequestered in the concrete blocks as a solid mineral. Excess gas, if any, is vented from the mold with a reduced concentration of carbon dioxide.

The carbonated mineral reaction products increase the early strength of the concrete. This allows accelerated curing to be eliminated or reduced in time or temperature or both. The energy consumption or total time, or both, of the block making process are thereby reduced. If steam curing would otherwise be used then, depending on how the energy for steam curing is generated, there may be a further reduction in the greenhouse gas emissions associated with making the blocks. The carbonated products may also exhibit one or more of decreased permeability or water absorption, higher durability, improved early strength and reduced in service shrinkage. The number of blocks that are damaged when the molds are stripped may also be reduced.

The apparatus and process may be adapted for use with other concrete articles, in particular other concrete articles produced at an industrial scale without embedded steel reinforcement, such as pavers, other decorative or structural masonry units, tiles or pipes, etc. The teachings herein are particularly well suited for, but not restricted to, the fabrication of concrete articles produced at an industrial scale without embedded steel reinforcement, such as pavers, other decorative or structural masonry units, tiles or pipes, etc. Described below are fabrication examples of a substantially planar product, namely a paver, and a hollow product, namely a concrete pipe. It will however be appreciated that other concrete articles, whether prismatic or hollow or hybrids thereof, may be produced by the apparatuses and processes described herein.

Carbonating the cementitious mixture in the mold during or at least directly after compaction (including shaking or vibrating), or both during and continuing after compaction, promotes a uniform and enhanced carbon dioxide uptake. Despite a short injection time, the carbon dioxide uptake may be a significant portion of the theoretical maximum uptake, which is approximately half of the mass of the cement in the mixture. Further, the resulting limestone is well distributed through the block product, thereby improving the material properties of the concrete article.

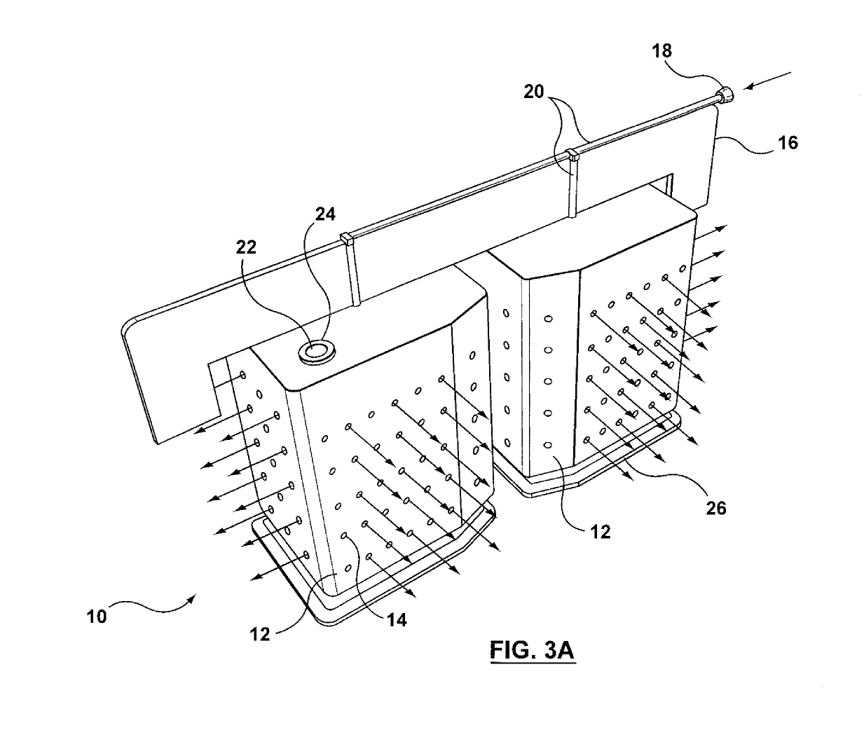

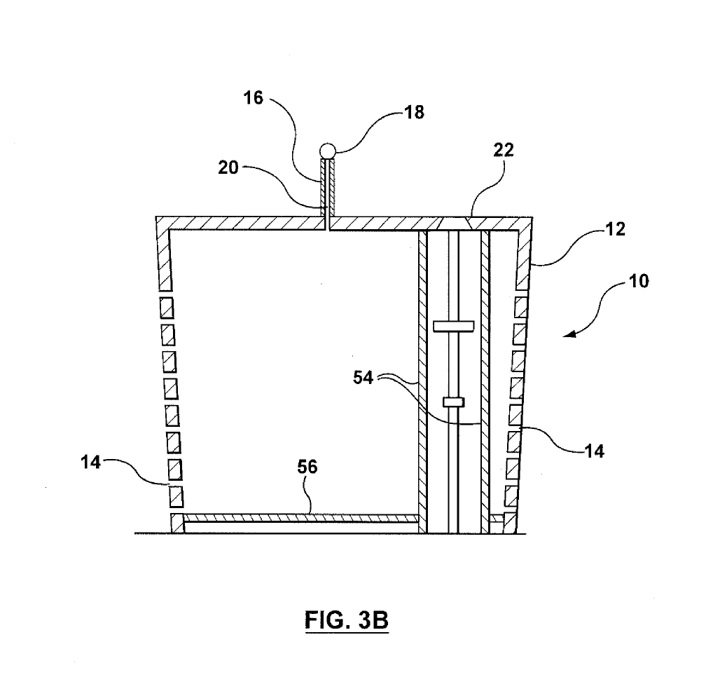

FIG. 3A shows a core assembly 10 adapted for injecting carbon dioxide into a concrete mold to form blocks. The core assembly 10 may be bolted into the concrete block mold as shown in FIG. 2 in place of the core assembly 112 shown therein. The core assembly 10 includes one or more core forms 12, the sides of which determine the size and shape of cavities in the finished block. The core forms 12 are hollow. The sides of the core forms 12 have small perforations 14 through the sides. The perforations provide a path for gas to flow from the hollow interior of the core forms 12 to the outside of the core forms 12, which will be located against the concrete when the mold is filled.

Only some of the perforations 14 are shown. The perforations 14 are preferably distributed generally uniformly across all surfaces of the core forms 12 that will be in contact with concrete. For example, the perforations 14 may be provided in a grid with the perforations separated by a 2 to 5 cm spacing interval, in a grid or offset grid pattern. The perforations 14 may be offset from the tops and bottoms of the core forms 12, for example by about 5 cm, to inhibit the carbon dioxide from bypassing the concrete or having a short residence time in the concrete near the top of the block. The number and size of perforations 14 is chosen to balance a desire to disperse ejected gas across the walls of the core forms, and a desire to provide some back pressure to gas flow to help equalize the gas flow rate through perforations 14 in different locations. Further, the size and number of the perforations 14 should be kept small enough so that the gas flow rate through each perforation is sufficient to push carbon dioxide through at least a significant portion of the thickness of the block wall, and to keep liquids or suspensions in the concrete mix from infiltrating the perforations 14.

The perforations 14 may be made by punching or drilling small, for example 1 mm to 3 mm in diameter, holes through the walls of the core forms 12 before hardening the steel walls of the core forms 12. When retrofitting an existing core assembly 10, the core assembly may be first heated to reverse its hardening before drilling the perforations 14, and then the core assembly 10 is re-hardened.

The perforations 14 may also be tapered through the thickness of the walls of the core forms 12 to produce a generally conical shaped hole, and having, for example, a diameter of 1/16″ at the interior of the core form 12 and a diameter of 3/32″ at the mold surfaces. The perforations 14 may also be declined pointing downwardly at an angle relative to horizontal, e.g., 10 to 20 degrees, so that the CO₂ is injected slightly downwardly into the concrete. This is intended to reduce plugging of the perforations 14 when the mold is filled and stripped.

A core bar 16 holds the core forms 12 together and attaches them to mounting flanges (not shown) for attaching the core assembly 10 to the frame of the mold. Tubes 20 provide a conduit for gas to flow from an inlet fitting 18 to the inside of the core forms 12. However, the size of any tubes 20 on the side of the core bar must be kept within the width of a slot in the scraper bars. The scraper bars typically have a clearance slot for the core bar 16, and these clearance slots may be widened slightly if required.

One or more vacuum breaker vents 22 may be used in many of the core forms 12. The vacuum breaker vent 22 is spring loaded to open to make it easier to lift the mold from the tray when stripping the molded blocks from the mold. The vacuum breaker vent 22 closes when the core form 12 is lowered onto a tray by way of a plunger protruding through the open bottom (as shown in FIG. 3B) of the core form 12. The vacuum breaker vent 22 closes to prevent concrete from falling into the core form 12, but it does not provide a gas tight seal. A gasket 24 may be added to the vent 22 as shown in FIG. 3A to form a seal. Alternatively, as shown in FIG. 3B, a tube or divider wall 54 may be added inside of the core form 12 to isolate the vacuum breaker vent assembly from the parts of the core form 12 that will contain gas for injection into the concrete.

While a mold form is being filled and compacted, the core forms 12 rest on a tray. The fit between the lower edge of the core form 12 and the tray may be sufficiently tight so as to prevent an unacceptable amount of gas leakage. If the fit is too loose, the lower edge of the core forms 12 may be fitted with a gasket 26 as shown in FIG. 3A. Space for the gasket 26 may be provided by putting spacers under the mounting flanges of the core bar 16, or by machining the lower surfaces of the core forms 12, which may also provide a flatter surface and allow a thinner gasket to be used. Alternatively, as shown in FIG. 3B, a lower plate 56 may be provided near the bottom of the core form 12 to provide a sealed plenum, but for the perforations 14. The lower plate 56 may be raised from the lower edge of the core form 12 to provide some tolerance for an uneven fit to the tray or small bits of concrete inadvertently located inside the core form 12 area of the mold.

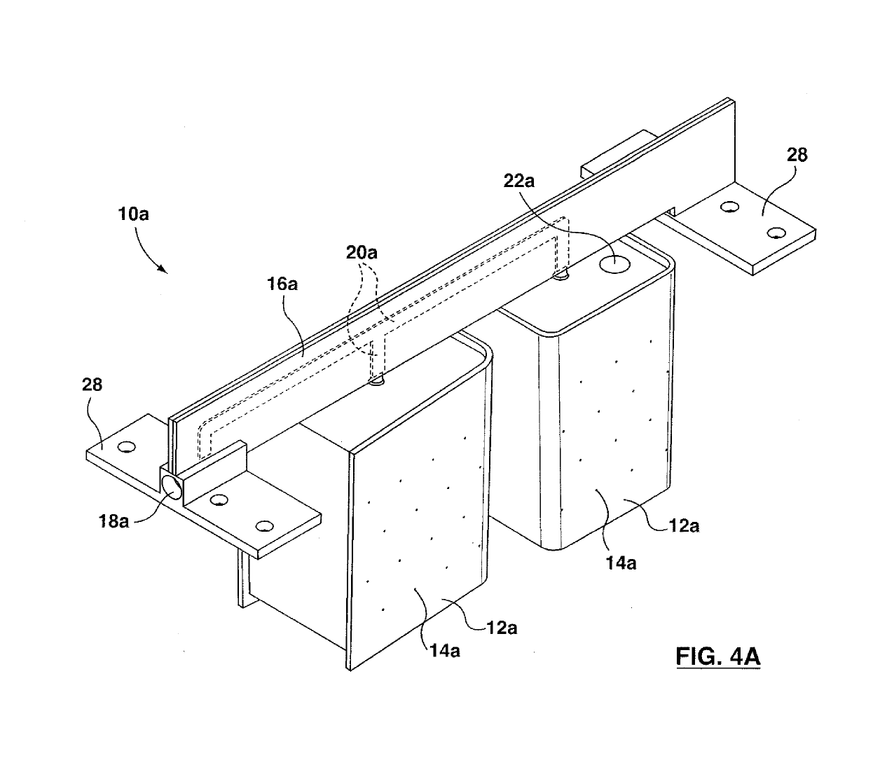

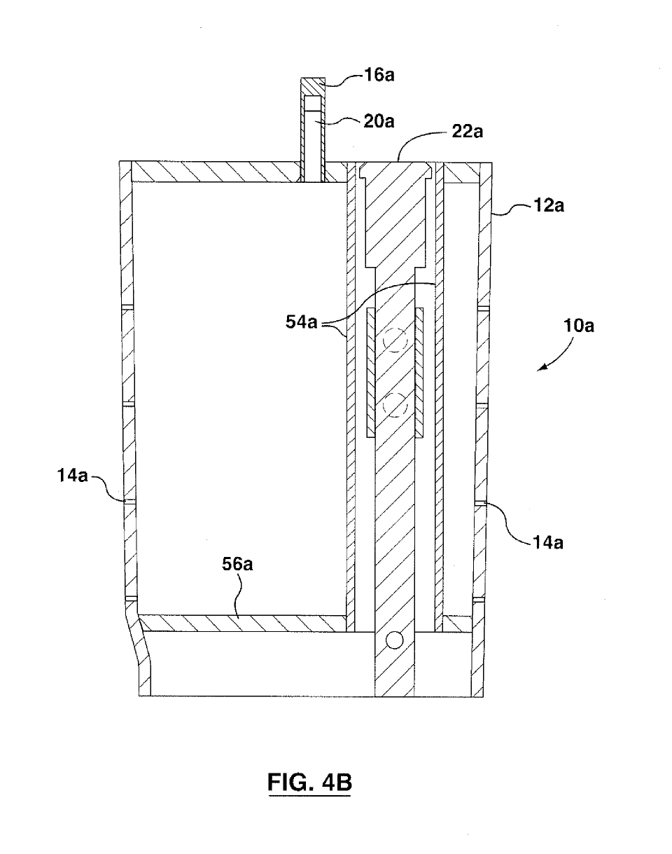

FIG. 4A shows another core assembly 10a adapted for injecting carbon dioxide into a concrete mold to form blocks. The core assembly 10a may also be bolted into the concrete block mold as shown in FIG. 2 in place of the core assembly 112 shown therein.

A core bar 16a holds core forms 12a together and attaches them to mounting flanges 28 for attaching the core assembly 10a to the frame of the mold. At one end of the core bar 16a, the mounting flange 28 includes an inlet fitting 18a. The core bar 16a includes an internal gas passage 20a in communication with the inlet fitting 18a. The core bar 16a may be made by welding the edges of two steel plates together. Each of the two plates has the same profile and about half of the thickness of a solid core bar. A small gap is left between the two plates to provide the internal gas passage 20a. One or more holes or a slot are cut in the top of the core forms 12a to communicate with the gas passage 20a in the core bar 16a through a gap or hole in the weld seam.

One or more vacuum breaker vents 22a may be used in many of the core forms 12a. The vacuum breaker vent 22a is spring loaded to open to make it easier to lift the mold from the tray when stripping the molded blocks from the mold. The vacuum breaker vent 22a closes when the core form 12a is lowered onto a tray by way of a plunger protruding through the open bottom (as shown in FIG. 4B) of the core form 12a. The vacuum breaker vent 22a closes to prevent concrete from falling into the core form 12a. In contrast to the core assembly 10 shown in FIG. 3A, no gasket is fitted to the lower edge of the core forms 12a.

As shown in FIG. 4B, a tube or divider wall 54a may be added inside of the core form 12a to isolate the vacuum breaker vent assembly from the parts of the core form 12a that will contain gas for injection into the concrete. A lower plate 56a may be provided near the bottom of the core form 12a to provide a sealed plenum, but for the perforations 14a. The lower plate 56a may be raised from the lower edge of the core form 12a to provide some tolerance for an uneven fit to the tray or small bits of concrete inadvertently located inside the core form 12a area of the mold.

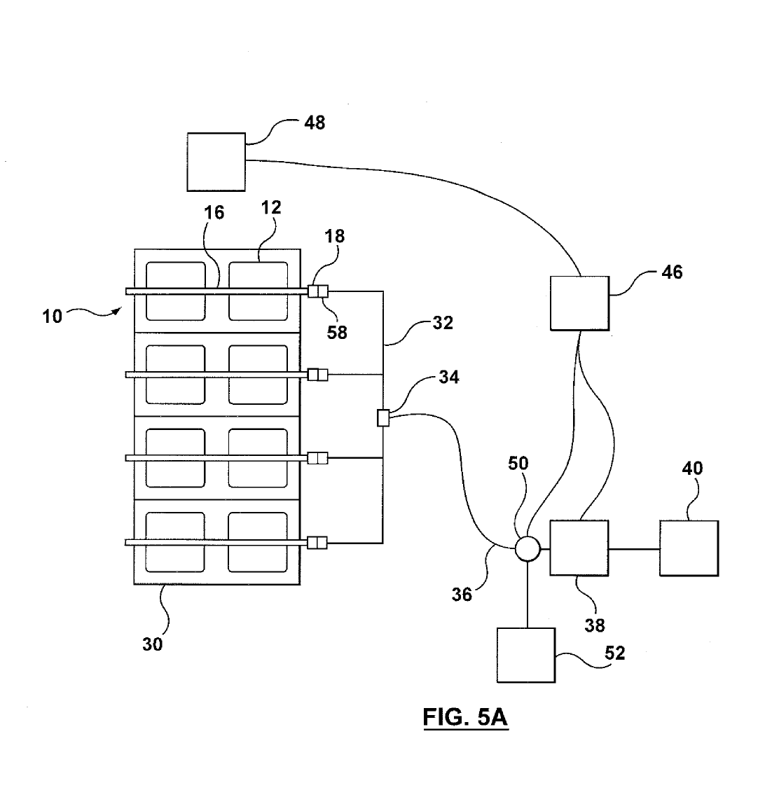

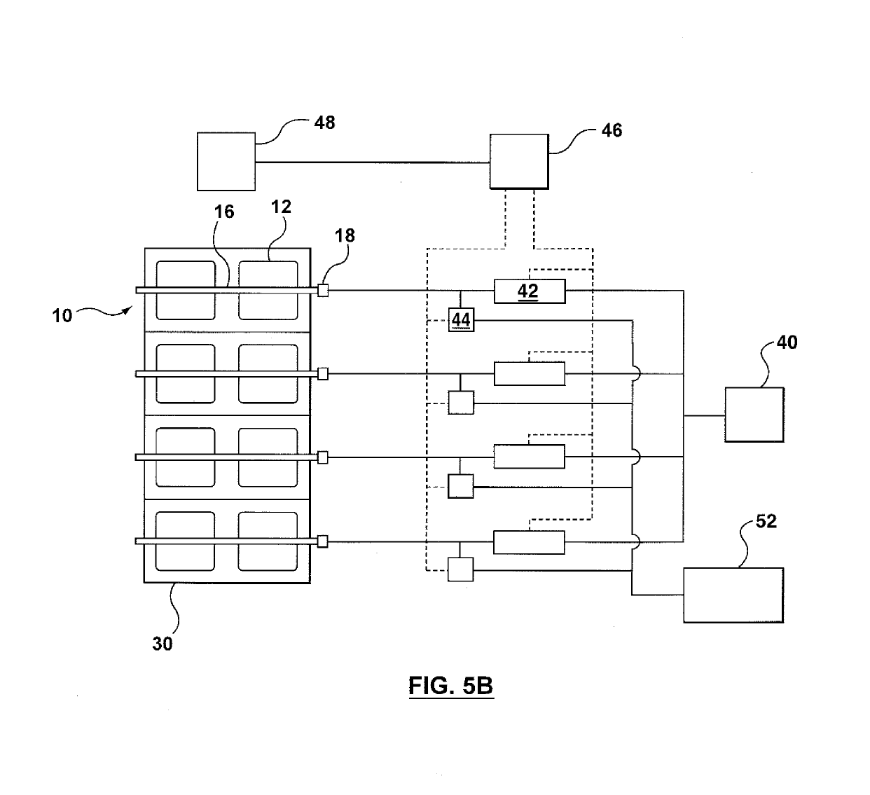

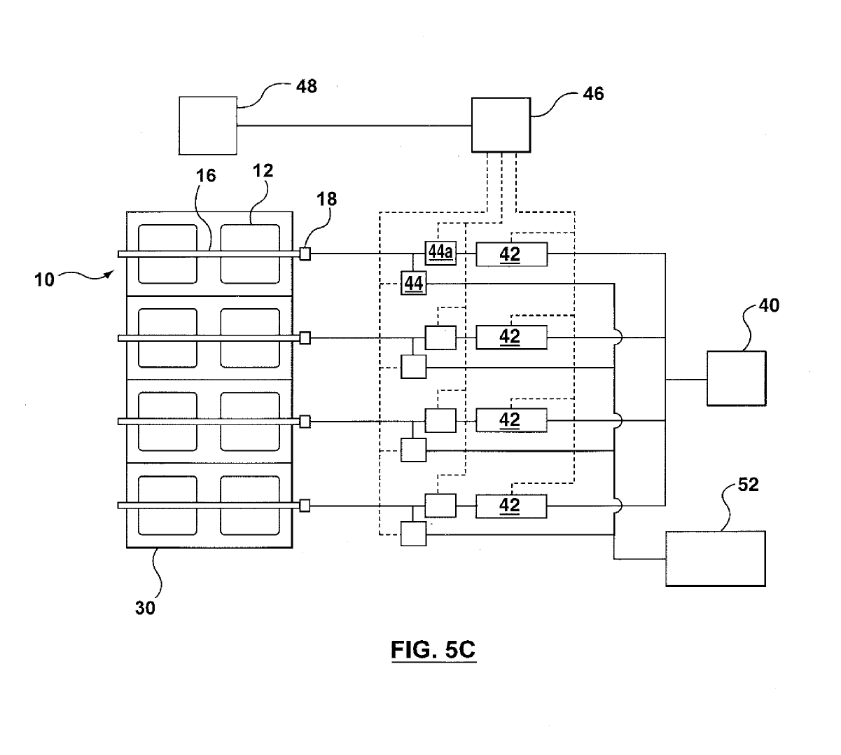

Referring to FIG. 5A, a mold form 30, viewed from above, has been fitted with one or more of the core assemblies 10 of FIGS. 3A and 3B (or the core assemblies 10a of FIGS. 4A and 4B). Inlets 18 of the core assemblies 10 may be connected to a gas inlet manifold 32. The manifold 32 is configured to provide a conduit between the inlet 18 on the core assembly 10 and a fitting 34 located out of the way of any moving parts of the molding machine 48. As shown, the inlets 18 of more than one core assembly 10 may be connected commonly to the manifold 32 and fitting 34, or alternatively a manifold may be provided for each core assembly. The manifold 32 is configured to not interfere with motion of the scraper bar or any other moving parts of the molding machine 48, and attached where vibration is relatively low. Each of the exit ports of the manifold 32 to the core assemblies 10 may include a calibrated orifice 58, which control the flow rate at which the gas exits the manifold 32. The orifices 58 can be swapped out during machine set up to allow for various flow rates. A desired flow rate and CO₂ quantity may be fixed on a case by case basis through a calibration step during setup that involves varying the supply pressure and the orifice 58.

The fitting 34 is connected by a gas feed line 36 to at least one gas supply valve 38. The line 36 is sufficiently flexible to allow the mold frame to shake for compaction. However, the line 36 should be sufficiently rigid or tied off, or both, to ensure that it does not move into any moving part of the molding machine. The valve 38 may include several gate valves which permit the incorporation of calibration equipment, e.g., one or more mass flow meters.

The valve 38 governs flow of pressurized gas coming from a pressurized gas supply 40. When the valve 38 is open, the pressurized gas including carbon dioxide flows from the pressurized gas supply 40 to the core assemblies 10 and through the perforations. The pressurized gas supply 40 may include, for example, a pressurized tank (not shown) filled with carbon dioxide containing gas, and a pressure regulator (not shown). The tank may be re-filled when near empty or kept filled by a compressor (not shown). The regulator may reduce the pressure in the tank to a maximum feed pressure. The maximum feed pressure may be above atmospheric, but below supercritical gas flow pressure. The feed pressure may be, for example, in a range from 120 to 350 kPa. A pressure relief valve (not shown) may be added to protect the carbon dioxide gas supply system components. The carbon dioxide gas is preferably supplied by the pressurized gas supply 40 at about room temperature. However, if not, a heater (not shown) may be added to bring the uncompressed gas up to roughly room temperature before flowing to the core assemblies 10.

Valve 38 is controlled by a controller 46. Controller 46 may be, for example, an electronic circuit or a programmable logic controller. In general, the controller manages carbon dioxide and compressed air flow. Controller 46 is connected to the molding machine 48 in such a way that the controller may sense when the molding machine has begun or stopped a stage of operation and thereby align carbon dioxide and compressed air injection with stages of operation of the molding machine 48. For example, controller 46 may be wired into an electrical controller or circuit of the molding machine such that during one or more stages of operation a voltage, current or other signal is provided to the controller 46. Alternatively or additionally, one or more sensors may be added to the molding machine adapted to advise the controller of conditions in the molding machine. When not retrofitted to an existing molding machine 48, the functions of the controller 46 may be integrated into a control system of the molding machine 48. Further alternatively, the controller 46 may consider a timer, a temperature sensor, a mass flow, flow rate or pressure meter in the gas feed line 36, or other devices in determining when to stop and start gas flow (e.g., a solenoid). In general, the controller 46 is adapted to open the valve 38 at a time beginning between when the feed tray adds concrete to the mold and the start of the mold shaking. The controller 46 closes the valve 38 after a desired amount of carbon dioxide has been injected over a desired period of time.

The controller 46 may also perform other functions. In particular, the controller 46 provides a burst of pressurized gas from time to time to clean out the perforations. For example, the controller 46 may open the valve 38 momentarily after the mold is stripped to provide a puff of carbon dioxide to clean out the perforations 14. Preferably, however, the perforations are cleaned with a burst of compressed air. Compressed air is provided in the system of FIG. 5A from a compressed air cylinder 52 (or alternatively an air compressor) connected to the line 36 through an air valve 50. The controller 46 closes the valve 38 and opens the air valve 50 to allow compressed air to flow through the perforations 14 to clean them out. The compressed air pressure may be 350 kPa or more. The compressed air may be provided for about 5 seconds between the block stripping and mold filling stages of the molding process in some or all of the molding machine cycles.

FIG. 5B shows an alternative configuration to the apparatus shown in FIG. 5A. The inlets 18 of the core assemblies 10 are connected to a mass flow meter 42, which in turn is connected to the pressurized gas supply 40. Gas flow rate to the core assemblies 10 is controlled using the mass flow meters 42. The inlets 18 are also connected to a compressed air solenoid 44, which in turn is connected to a compressed air cylinder 52 or air compressor.

Each of the mass flow meters 42 and the compressed air solenoids 44 are controlled by the controller 46. In general, the controller 46 manages carbon dioxide and compressed air flow to the core assemblies 10, as described above.

Additionally, as shown in FIG. 5C, a CO₂ solenoid 44a may be provided between the inlets 18 and the mass flow meter. Each of the mass flow meters 42, the CO₂ solenoids 44a and the compressed air solenoids 44 are controlled by the controller 46. Again, the controller 46 manages carbon dioxide and compressed air flow to the core assemblies 10, as described above.

The gas for injection into the concrete preferably has a high concentration of carbon dioxide, and minimal concentrations of any gases or particulates that would be detrimental to the concrete curing process or to the properties of the cured concrete. The gas may be a commercially supplied high purity carbon dioxide. In this case, the commercial gas may be sourced from a supplier that processes spent flue gasses or other waste carbon dioxide so that sequestering the carbon dioxide in the gas sequesters carbon dioxide that would otherwise be a greenhouse gas emission.

Other gases that are not detrimental to the curing process or concrete product may be included in an injected gas mixture. However, if the gas includes other gases besides carbon dioxide, then the required flow rate and pressure are determined based on the carbon dioxide portion of the gas alone. The total flow rate and pressure need to remain below a level that prevents the formation of bubbles or sprays concrete materials out of the mold, which may limit the allowable portion of non-carbon dioxide gases. In some cases, on site or nearby as-captured flue gas may be used to supply some or all of the gas containing carbon dioxide, although some particulate filtering or gas separation may be required or desirable.

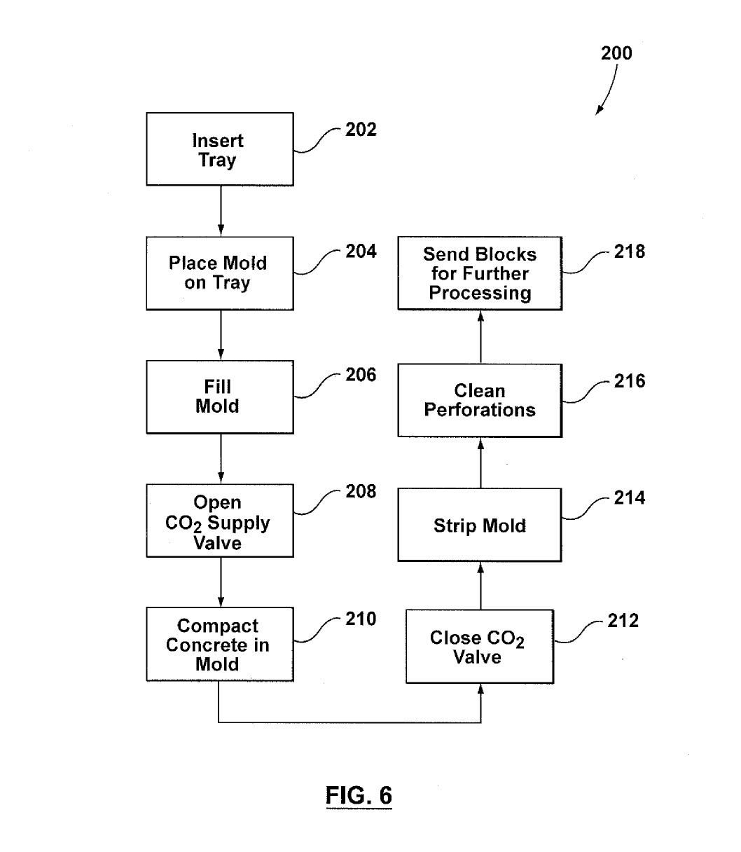

In general, carbon dioxide is injected into the concrete mixture during mold compaction via a perforated ventilation system. Referring to FIG. 6, a process 200 begins by inserting a tray into a molding machine in step 202. In step 204, a mold is placed on the tray. In step 206, the mold is filled with concrete from a hopper and excess material is scraped away. In step 208, which may be concurrent with step 206, a gas valve is opened to start injecting carbon dioxide into the mold form. In step 210, the mold form is compacted, for example by lowering a compaction arm and shaking the compaction arm. In step 212, the gas valve is closed to stop injecting carbon dioxide into the mold form. In step 214, the mold is stripped by raising the mold and then the compaction arm. In step 216, a timed burst of compressed air to clean the perforations also begins when the bottom of the mold has been raised above the top of the blocks or shortly after that. In step 218, the tray with molded blocks is removed for further processing such as further curing, if any, packaging and distribution. The stripped blocks may continue to a steam or heat curing process, however the time or temperature of the curing required to produce a desired strength may be reduced. Optionally, flue gas from the steam or heat curing may be recaptured and injected into other blocks.

The exact order of steps 204, 206, 208, 210, 212, 214, 216 and 218 may be varied, but preferably carbon dioxide is injected at least during step 208 while the concrete is being shaken. The inventors believe that shaking or vibration during carbon dioxide injection facilitates an even distribution and mixing of the carbon dioxide within the concrete. With a rapid injection, for example injecting carbon dioxide for 60 seconds or less, the injection process only minimally slows the molding operation, if at all. In some cases, carbon dioxide need only be injected for 15 seconds or less, or even 6 seconds or less. The rapid injection distributes carbon dioxide throughout the concrete mix before the carbonation reactions make the concrete less porous. The vibration or shaking does not inhibit the calcium carbonate forming reactions, but may encourage the formation of smaller calcium carbonate deposits, or mixing of formed carbonate deposits, such that the concrete remains more permeable to carbon dioxide during the injection period.

If the injected gas contains essentially only carbon dioxide or other non-polluting gases or particulates not detrimental to health, then any excess gas not absorbed by the concrete may be allowed to enter the atmosphere. Provided that the total amount of carbon dioxide per cycle does not exceed the maximum possible carbon uptake, very little carbon dioxide will be emitted. However, particularly if un-separated flue gas is used to supply the carbon dioxide, other gasses may be emitted. Gases leaving the mold may be collected by a suction pressure ventilation system, such as a fume hood or chamber, for health and safety or pollution abatement considerations.

A negative pressure ventilation system may also promote more thorough gas mixing within the concrete material.

An increased quantity or distribution of carbon dioxide may also be provided by modifying the mold frame. For example, the division plates in the mold could be replaced with a pair of spaced, edge welded, perforated plates (analogous to the bar 16 of FIG. 3B) to provide further sites for carbon dioxide injection sites. If necessary, all molding surfaces of the mold frame could be used as injection sites, which would minimize the maximum distance between an injection point and the inside of the concrete mass. However, testing indicates that injecting concrete though the core assembly 10 alone may be sufficient. Modifying the core assembly 10 as described herein also appears to be the easiest way to modify an existing mold.

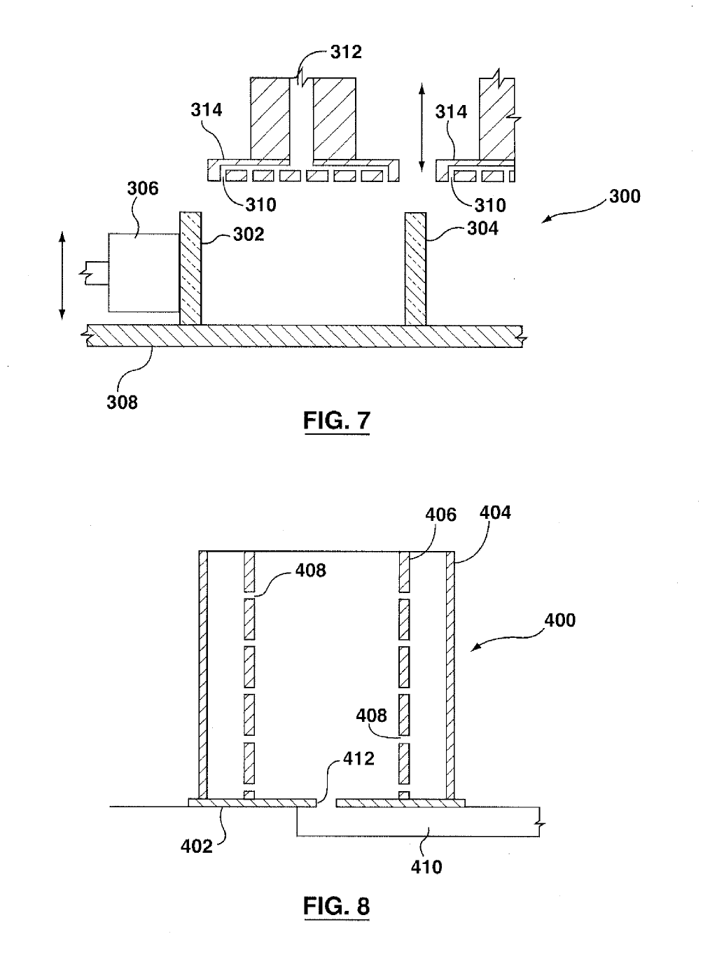

Referring now to FIG. 7, a mold assembly 300 is shown adapted to form substantially planar products, such as concrete pavers or paving stones. The mold assembly 300 includes an end plate 302, one or more division plates 304, and a tray 308, along with sidewalls (not shown), which determine the size and shape of the pavers. The division plates 304 separate each of the pavers, aligned in a row, with another end plate provided at the end of the row opposite from the end plate 302. There may be 5, 6 or more pavers aligned in the row in the mold assembly 300. A lateral brace 306 provides support to the end plate 302. Shoe elements 314 are descended vertically into the mold to compact the concrete.

At least a portion of each of the shoe elements 314 includes a plurality of perforations 310 for carbon dioxide injection. The perforations 310 provide a path for carbon dioxide rich gas to flow from the hollow interior of a gas supply conduit 312 into the concrete when the mold assembly 300 is filled. After the mold has been filled with concrete and compacted, the plates 302, 304, the lateral brace 306 and the shoe elements 314 may be raised upwardly together away from the base plate 308 to allow the concrete pavers to be removed for further processing.

As described above, the perforations 310 may be distributed generally uniformly across the shoe element 314, and the number and size of perforations 310 may be chosen to provide that the gas flow rate is generally equalized through perforations 310 in different locations across the shoe element 314. Further, the size and number of the perforations 310 should be kept small enough so that the gas flow rate through each perforation 310 is sufficient to keep liquids or suspensions in the concrete mix from infiltrating the perforations 310.

In some cases, the perforations 310 may not be exactly uniform across the shoe element 314. For example, the perforations 310 may be arranged to have a higher density towards the center region of the paver, with less arranged around the peripheral area of the paver. The perforations 310 may also be arranged offset from the plates 302, 304 and the sidewalls to inhibit the carbon dioxide from bypassing the concrete.

In other cases, alternatively or in addition to the perforations 310 in the shoe elements 314, perforations may also be provided in the plates 302, 304 and/or the sidewalls.

Referring to FIG. 8, a mold assembly 400 is shown adapted to form hollow products, such as pipes. The mold assembly 400 includes a base plate 402 and outer and inner mold walls 404, 406 extending upwardly from the base plate 402. The walls 404, 406 are generally cylindrical and generally concentrically arranged, defining an annular shaped mold. The inner mold wall 406 includes a plurality of perforations 408. Carbon dioxide rich gas flows upwardly from the hollow interior of a gas supply conduit 410, through an aperture 412 in the base plate 402, and the perforations 408 provide a flow path radially outwardly into the concrete when the mold assembly 400 is filled. Depending on the type of pipe to be formed, an annular rebar support (not shown) may be arranged between the walls 404, 406 prior to filling with concrete. After the mold has been filled with concrete, the walls 404, 406 may be raised upwardly away from the base plate 402 to allow the concrete pipe to be removed for further processing.

As described above, the perforations 408 may be offset from the top of the wall 406 to inhibit the carbon dioxide from bypassing the concrete or having a short residence time in the concrete near the top of the pipe. The perforations 408 may also be tapered through the thickness to produce a generally conical shaped hole, and may be declined pointing downwardly so that the CO₂ is injected slightly downwardly.

Residence time of pipes in the mold assembly 400 may be considerably longer than 60 seconds, e.g., 3 or 4 minutes, and carbon dioxide may be injected through the perforations 408 for all or only a portion of the residence time.

### Examples

A concrete block plant was modified to allow for carbon dioxide injection. The plant uses a CPM 40 four block molding machine manufactured by Columbia Machine, Inc. The molds used with the machine have four cavities, each producing a standard 8″ (20 cm) stretcher block of the type often used to make concrete block walls. Each block is 390 mm long and 190 mm wide in plan view. The thickness of the walls of the block ranges from 26 to 32 mm. Each block has a nominal weight of 17 kg.

The plant ordinarily operates on a single day shift production cycle. Blocks produced in a day are ordinarily placed in a steam chamber by about 4 μm and removed between 6 and 9 am on the second day after they were produced. The steam curing is done at about atmospheric pressure. Temperature is initially held for 60 minutes at 32° C. The temperature is then increased at 20° C./hour to 55° C. This temperature is held for 3 to 4 hours at 55° C. After that period of time, no further heat is applied but the blocks remain in the closed chamber as temperature decays.

In the tests to be described below, the core assemblies of the mold were replaced with core assemblies generally as shown in FIGS. 3A and 3B. Two perforation hole patterns were evaluated. The standard concrete mix included 125 kg of Portland cement, 15 kg of fly ash, 1180 kg of sand, 425 kg of stone and 250 mL of an admixture, Rheomix 750s. Approximately 40 L of water was added, but the exact amount was adjusted to make a dry mix that does not pour or flow, but is self supporting after compaction. The quantities in the mix design make a 0.688 cubic metre batch. A smaller version of this batch was also used (93 kg cement, 11 kg fly ash, 888 kg sand, 337 kg stone, and 188 ml of Rheomix).

An additional mix was tested that involved lowering the content of the binder (cement and fly ash) in the mix. It was termed to be a “lean” mix and involved a 10% reduction in the binder content. The proportions used were 84 kg cement, 9 kg fly ash, 888 kg sand, 337 kg stone, and 188 ml of Rheomix.

The normal molding cycle time of about 9 to 12 seconds was increased as required to allow various carbon dioxide injection times and quantities. The temperature of the hold portion of the steam chamber temperature profile was modified in some tests.

The carbon dioxide used for the test was unblended, substantially pure, carbon dioxide sourced from a large final emitter and provided by an industrial gas supplier. The maximum amount of carbon dioxide injected into each block in a given test was 250 g. This represents slightly more than 20% of the mass of cement in a block, or about 40% of the theoretical maximum uptake of carbon dioxide. Various amounts of carbon dioxide lower than this amount were also tried. The amount of CO₂ that was actually absorbed in each block has not yet been determined. However, the increase in strength noted in the tests suggests that at least a significant portion of the carbon dioxide was absorbed. The gas pressure was allowed to vary as required to supply the desired mass of carbon dioxide over the various injection times tested. The pressure at any particular time in any of the tests is not known. However, the minimum line pressure in any test was 2.5 psig (about 20 kPa above atmospheric pressure). A pressure release valve set at 20 psig (about 140 kPa above atmospheric pressure) was triggered in some tests. A second pressure release valve set at 50 psig (about 350 kPa above atmospheric pressure) was not triggered in any test.

The maximum flow rate in any test was about 700 litres per minute. At this upper limit, damage to the concrete was observed, including pits associated with gas travel, and resulting blocks which were underweight. Block volume according to the test results below was about 8.1 litres of concrete, and thus a maximum flow rate for gas injection may be expressed as about 86 LPM of gas per litre of concrete.

Tables 1 through 3 show the results of 24 hour and 7 day testing of blocks produced under various test conditions using the standard mix design and steam curing at 55° C. In each table, the designation given in the column labeled Block ID provided a code to describe the production sequence of the set of blocks. The column labeled “Condition” distinguishes between control (uncarbonated) and CO₂ (carbonated) blocks. The column labeled “CO₂ time” gives the number of seconds during which carbon dioxide flowed through the core bars. The blocks were shaken during this time for the ordinary shaking time of the molding machine, which was about 5 seconds. The machine paused after shaking to allow for the carbon dioxide injection times tested to be completed. The column labeled “CO₂ dose” gives the amount of CO₂ in grams which was introduced to the blocks through the core bars. The column labeled “Flowrate” describes the litres per minute flow of the CO₂ as it supplied the prescribed dose over the prescribed time. The column labeled “Peak Stress” gives the compressive strength in MPa of a block tested at the time mentioned in the table label and subjected to the outlined production details. The final two columns provide a comparison between the CO₂ and control blocks by calculating an absolute difference between the strength of a given CO₂ block and the average control block strength, as well as the difference between an averaged CO₂ block strength for a given set of conditions and the average control performance. The final column expresses the difference as a percentage above or below the average control strength.

In Table 1, the results are presented and show that the carbonation of blocks using 250 g of CO₂ over a period of 15 seconds prior to standard steam curing treatment resulted in an increase in strength in excess of 13%.

In Table 2, 7 day strength results are presented for various tests that used 15, 30 or 60 seconds of CO₂ exposure. For the given dose of 250 g it was shown that an injection time of 15 seconds resulted in strength improvements that were comparable to using an injection time of 60 seconds.

In Table 3, 7 day test results are presented for various normal mix design tests using injection times of 15 or 10 seconds and CO₂ doses of 250, 150, or 75 g. It is seen that within consideration of 15 seconds injection times the strength benefit is continued to be realized as the CO₂ dose is reduced from 250 to 150 to 75 g. It is seen that the 7 day strength benefit is an improvement in excess of 15%. It is thought that the reduced CO₂ dose is a more efficient use of the carbon dioxide if the increasing dose does not correlate with an increasing strength benefit. Results are also presented for injection times of 10 seconds. When the dose is 150 g it is suggested that the strength benefit realized from a 10 second injection time is less than half of that when the same dose was injected over 15 seconds. However, if the dose is 75 g the benefit is about the same whether the injection time is 15 seconds or 10 seconds.

TABLE 1
24 hour strength of samples made with
normal mix design and cured at 55° C.

| | | CO₂ | CO₂ | | Peak | | |
|---|---|---|---|---|---|---|---|
| Block | Condi- | time | dose | Flowrate | Stress | Diff. vs avg Control | |
| ID | tion | (s) | (g) | (LPM) | (MPa) | Abs. | % diff |
| 303A | Control | 0 | — | — | 14.8 | — | — |
| 312A | Control | 0 | — | — | 11.5 | — | — |
| 318A | Control | 0 | — | — | 13.4 | — | — |
| Avg Control | | | | | 13.2 | — | — |
| 301C | CO₂ | 15 | 250 | 547 | 14.2 | +1.0 | +7.4% |
| 302D | CO₂ | 15 | 250 | 547 | 15.4 | +2.2 | +16.7% |
| 303D | CO₂ | 15 | 250 | 547 | 15.5 | +2.3 | +17.0% |

| | | | |
|---|---|---|---|
| Avg CO₂ 15-250-547 | 15.1 | +1.8 | +13.7% |

TABLE 2
7 day strength of samples made with normal
mix design (trial 1) and cured at 55° C.

| | | CO₂ | CO₂ | | Peak | | |
|---|---|---|---|---|---|---|---|
| Block | Condi- | time | dose | Flowrate | Stress | Diff. vs avg Control | |
| ID | tion | (g) | (g) | (LPM) | (MPa) | Abs. | % diff |
| 191A | Control | — | — | — | 18.9 | — | — |
| 192A | Control | — | — | — | 17.6 | — | — |
| Avg Control | | | | | 18.3 | — | — |
| 194C | CO₂ | 15 | 250 | 547 | 19.6 | +1.3 | +6.5% |
| 194D | CO₂ | 15 | 250 | 547 | 19.8 | +1.5 | +7.8% |
| Avg CO₂ 15-250-547 | | | | | 19.7 | +1.4 | +7.2% |
| 191C | CO₂ | 30 | 250 | 273 | 21.1 | +2.8 | +13.3% |
| 191D | CO₂ | 30 | 250 | 273 | 21.9 | +3.6 | +16.5% |
| 192C | CO₂ | 30 | 250 | 273 | 20.6 | +2.3 | +11.1% |
| 192D | CO₂ | 30 | 250 | 273 | 21.0 | +2.7 | +12.9% |
| Avg CO₂ 30-250-273 | | | | | 21.1 | +2.8 | +13.5% |
| 198C | CO₂ | 60 | 250 | 137 | 20.1 | +1.8 | +8.9% |
| 198D | CO₂ | 60 | 250 | 137 | 19.3 | +1.0 | +5.1% |

| | | | |
|---|---|---|---|
| Avg CO₂ 60-250-137 | 19.7 | +1.4 | +7.0% |

TABLE 3
7 day strength of samples made with normal
mix design (trial 3) and cured at 55° C.

| | | CO₂ | CO₂ | | Peak | | |
|---|---|---|---|---|---|---|---|
| Block | Condi- | time | dose | Flowrate | Stress | Diff. vs avg Control | |
| ID | tion | (g) | (g) | (LPM) | (MPa) | Abs. | % diff |
| 302A | Control | — | — | — | 22.9 | — | — |
| 310A | Control | — | — | — | 16.1 | — | — |
| 317A | Control | — | — | — | 17.9 | — | — |
| Avg Control | | | | | 19.0 | — | — |
| 301D | CO₂ | 15 | 250 | 547 | 21.8 | +2.8 | +14.8% |
| 302C | CO₂ | 15 | 250 | 547 | 21.0 | +2.1 | +10.8% |
| 303C | CO₂ | 15 | 250 | 547 | 22.0 | +3.0 | +16.1% |
| Avg CO₂ 15-250-547 | | | | | 21.6 | +2.6 | +13.9% |
| 304C | CO₂ | 15 | 150 | 328 | 19.7 | +0.7 | +3.9% |
| 305D | CO₂ | 15 | 150 | 328 | 24.0 | +5.0 | +26.2% |
| 306D | CO₂ | 15 | 150 | 328 | 22.4 | +3.4 | +17.8% |
| Avg CO₂ 15-150-328 | | | | | 22.0 | +3.0 | +16.0% |
| 307D | CO₂ | 15 | 75 | 164 | 22.7 | +3.7 | +19.4% |
| 308C | CO₂ | 15 | 75 | 164 | 22.2 | +3.2 | +17.0% |
| 309D | CO₂ | 15 | 75 | 164 | 22.9 | +3.9 | +20.7% |
| Avg CO₂ 15-75-164 | | | | | 22.6 | +3.6 | +19.0% |
| 313D | CO₂ | 10 | 150 | 492 | 21.9 | +2.9 | +15.4% |
| 314C | CO₂ | 10 | 150 | 492 | 19.4 | +0.4 | +2.4% |
| 315C | CO₂ | 10 | 150 | 492 | 19.5 | +0.5 | +2.5% |
| Avg CO₂ 10-150-492 | | | | | 20.3 | +1.3 | +6.8% |
| 316C | CO₂ | 10 | 75 | 246 | 20.5 | +1.5 | +7.7% |
| 317C | CO₂ | 10 | 75 | 246 | 23.0 | +4.0 | +21.0% |
| 318D | CO₂ | 10 | 75 | 246 | 23.6 | +4.6 | +24.4% |

| | | | |
|---|---|---|---|
| Avg CO₂ 10-75-246 | 22.3 | +3.4 | +17.7% |

The results suggest that carbon dioxide injection is likely to permit a reduction in steam temperature (and therefore energy use and greenhouse gas emissions) while providing a block product with at least ordinary strength. Alternately, or in conjunction, it is suggested that the carbon dioxide injection is likely to permit a reduction in the binder content (and therefore greenhouse gas emissions associated with cement production) while providing a block product with at least ordinary strength. None of the tests suggested any significant decrease in strength, and the strength of the blocks was improved under various carbon dioxide and curing conditions.

Tables 4 through 7 show the results of 24 hour and 7 day testing of blocks produced under various test conditions using the standard mix design and steam curing at 45° C. In each table, the columns are labeled and constructed as outlined above.

In Table 4, 24 hour strength results are presented in tests that injected either 250 or 150 g of CO₂ over 15 seconds and a 10° C. reduction in curing temperature. It was shown that for both CO₂ treatments the result was an improvement of the strength (8% for 150 g, 9.3% for 250 g).

In Table 5, 7 day strength results is presented for a test in which 250 g of CO₂ was injected over 30 seconds before steam curing at the reduced 45° C. temperature. The CO₂ treatment resulted in an improved strength on the order of 14%.

In Table 6, 7 day strength results are presented for a test in which 250 or 150 g of CO₂ is injected over a time of 15 seconds before steam curing at the reduced 45° C. temperature. It is observed that the average strength of the blocks that received 250 g of CO₂ was 10.6% stronger at 7 days than the average strength of the uncarbonated control blocks. Additionally, it is observed that the average strength of the blocks that received 150 g of CO₂ was more than 23% stronger at 7 days than the average strength of the uncarbonated control blocks.

Table 7 shows 7 day strength result for a test in which 150 g of CO₂ is injected over a time of 15 seconds before steam curing at the reduced 45° C. temperature. This test is a repeat of a test presented in Table 6. While the actual control mix may vary slightly from day to day (largely due to the variability of the water content of the aggregates and the attendant compensation of the mix water), it is shown that the carbonation treatment still offered a strength benefit.

TABLE 4
24 hour strength of samples made with
normal mix design and cured at 45° C.

| | | CO₂ | CO₂ | | Peak | | |
|---|---|---|---|---|---|---|---|
| Block | Condi- | time | dose | Flowrate | Stress | Diff. vs avg Control | |
| ID | tion | (s) | (g) | (LPM) | (MPa) | Abs. | % diff |
| 401A | Control | — | — | — | 13.2 | — | — |
| 402B | Control | — | — | — | 11.7 | — | — |
| 403B | Control | — | — | — | 12.3 | — | — |
| Avg Control | | | | | 12.4 | — | — |
| 319D | CO₂ | 15 | 250 | 547 | 13.5 | +0.3 | +2.6% |
| 320D | CO₂ | 15 | 250 | 547 | 13.6 | +1.9 | +16.1% |
| 321D | CO₂ | 15 | 250 | 547 | 13.6 | +1.2 | +10.1% |
| Avg CO₂ 15-250-547 | | | | | 13.6 | +1.2 | +9.3% |
| 401C | CO₂ | 15 | 150 | 328 | 12.6 | +0.2 | +1.5% |
| 402D | CO₂ | 15 | 150 | 328 | 13.9 | +1.5 | +11.8% |
| 403D | CO₂ | 15 | 150 | 328 | 13.7 | +1.3 | +10.7% |

| | | | |
|---|---|---|---|
| Avg CO₂ 15-150-328 | 13.4 | +1.0 | +8.0% |

TABLE 5
7 day strength of samples made with normal
mix design and cured at 45° C. (trial 1).

| | | CO₂ | CO₂ | | Peak | | |
|---|---|---|---|---|---|---|---|
| Block | Condi- | time | dose | Flowrate | Stress | Diff. vs avg Control | |
| ID | tion | (g) | (g) | (LPM) | (MPa) | Abs. | % diff |
| 109A | Control | — | — | — | 16.7 | — | — |
| 110A | Control | — | — | — | 15.8 | — | — |
| Avg Control | | | | | 16.3 | — | — |
| 109C | CO₂ | 30 | 250 | 273 | 18.3 | +2.0 | +10.8% |
| 109D | CO₂ | 30 | 250 | 273 | 19.7 | +3.4 | +17.2% |

| | | | |
|---|---|---|---|
| Avg CO₂ 30-250-273 | 19.0 | +2.7 | +14.1% |

TABLE 6
7 day strength of samples made with normal
mix design and cured at 45° C. (trial 3).

| | | CO₂ | CO₂ | | Peak | | |
|---|---|---|---|---|---|---|---|
| Block | Condi- | time | dose | Flowrate | Stress | Diff. vs avg Control | |
| ID | tion | (g) | (g) | (LPM) | (MPa) | Abs. | % diff |
| 320A | Control | — | — | — | 22.5 | — | — |
| 328B | Control | — | — | — | 20.2 | — | — |
| 335B | Control | — | — | — | 17.9 | — | — |
| Avg Control | | | | | 20.2 | — | — |
| 319C | CO₂ | 15 | 250 | 547 | 23.8 | +3.6 | +17.9% |
| 320C | CO₂ | 15 | 250 | 547 | 22.8 | +2.6 | +12.7% |
| 321C | CO₂ | 15 | 250 | 547 | 20.5 | +0.3 | +1.3% |
| Avg CO₂ 15-250-547 | | | | | 22.4 | +2.2 | +10.6% |
| 322C | CO₂ | 15 | 150 | 328 | 23.2 | +3.0 | +14.8% |
| 323D | CO₂ | 15 | 150 | 328 | 25.3 | +5.1 | +25.3% |
| 324C | CO₂ | 15 | 150 | 328 | 26.2 | +6.0 | +29.7% |

| | | | |
|---|---|---|---|
| Avg CO₂ 15-150-328 | 24.9 | +4.7 | +23.3% |

TABLE 7
7 day strength of samples made with normal
mix design and cured at 45° C. (trial 4).

| | | CO₂ | CO₂ | | Peak | | |
|---|---|---|---|---|---|---|---|
| Block | Condi- | time | dose | Flowrate | Stress | Diff. vs avg Control | |
| ID | tion | (g) | (g) | (LPM) | (MPa) | Abs. | % diff |
| 403A | Control | — | — | — | 18.0 | — | — |
| 404A | Control | — | — | — | 20.1 | — | — |
| 405B | Control | — | — | — | 18.8 | — | — |
| Avg Control | | | | | 19.0 | — | — |
| 403C | CO₂ | 15 | 150 | 328 | 19.5 | +0.5 | +2.7% |
| 404D | CO₂ | 15 | 150 | 328 | 21.0 | +2.0 | +10.8% |
| 405C | CO₂ | 15 | 150 | 328 | 19.6 | +0.6 | +3.3% |

| | | | |
|---|---|---|---|
| Avg CO₂ 15-150-328 | 20.0 | +1.1 | +5.6% |

Tables 8 and 9 show the results of 24 hour and 7 day testing of blocks produced under various test conditions using the lean mix design and steam curing at 55° C. In each table, the columns are labeled and constructed as outlined above.

In Table 8 the results show that for a reduction of the binder content by 10% a treatment involving 150 g of CO₂ over 15 seconds was sufficient to improve the strength by about 7% at 24 hours.

In Table 9 results are presented that detail the 7 day strengths measured for lean mix design concrete cured at 55° C. but subjected to either no carbonation, 75 g CO₂ in 10 sec, 75 g CO₂ in 15 sec, or 150 g CO₂ in 15 sec. The 10 second treatment on average improved the 7 day strength by almost 10%. The 75 g CO₂ at 15 second arguably had no effect on the strength. 150 g CO₂ at 15 second resulted in 2.6% increase in strength.

TABLE 8
24 hour strength of samples made with
lean mix design and cured at 55° C.

| | | CO₂ | CO₂ | | Peak | | |
|---|---|---|---|---|---|---|---|
| Block | Condi- | time | dose | Flowrate | Stress | Diff. vs avg Control | |
| ID | tion | (s) | (g) | (LPM) | (MPa) | Abs. | % diff |
| 425B | Control | — | — | — | 11.4 | — | — |
| 426A | Control | — | — | — | 10.8 | — | — |
| 427A | Control | — | — | — | 10.8 | — | — |
| Avg Control | | | | | 11.0 | — | — |
| 425D | CO₂ | 15 | 150 | 328 | 12.4 | +1.4 | +12.5% |
| 426C | CO₂ | 15 | 150 | 328 | 11.2 | +0.2 | +1.5% |
| 427D | CO₂ | 15 | 150 | 328 | 11.9 | +0.9 | +7.8% |

| | | | |
|---|---|---|---|
| Avg CO₂ 15-150-328 | 11.8 | +0.8 | +7.3% |

TABLE 9
7 day strength of samples made with
lean mix design and cured at 55° C.

| | | CO₂ | CO₂ | | Peak | | |
|---|---|---|---|---|---|---|---|
| Block | Condi- | time | dose | Flowrate | Stress | Diff. vs avg Control | |
| ID | tion | (s) | (g) | (LPM) | (MPa) | Abs. | % diff |
| 425A | Control | — | — | — | 16.2 | — | — |
| 426B | Control | — | — | — | 16.8 | — | — |
| 427A | Control | — | — | — | 17.4 | — | — |
| Avg Control | | | | | 16.8 | — | — |
| 421D | CO₂ | 10 | 75 | 246 | 17.8 | +1.0 | +6.2% |
| 422C | CO₂ | 10 | 75 | 246 | 18.6 | +1.8 | +10.9% |
| 423D | CO₂ | 10 | 75 | 246 | 18.7 | +1.9 | +11.3% |
| Avg CO₂ 10-75-246 | | | | | 18.4 | +1.6 | +9.5% |
| 425C | CO₂ | 15 | 150 | 328 | 15.5 | −1.3 | −7.6% |
| 426D | CO₂ | 15 | 150 | 328 | 17.2 | +0.4 | +2.6% |
| 427C | CO₂ | 15 | 150 | 328 | 19.0 | +2.2 | +12.8% |
| Avg CO₂ 15-150-328 | | | | | 17.2 | +0.4 | +2.6% |
| 429C | CO₂ | 15 | 75 | 164 | 15.5 | −1.3 | −7.5% |
| 430C | CO₂ | 15 | 75 | 164 | 16.8 | −0.0 | −0.1% |
| 431D | CO₂ | 15 | 75 | 164 | 18.0 | +1.2 | +7.2% |

| | | | |
|---|---|---|---|
| Avg CO₂ 15-75-164 | 16.8 | −0.0 | −0.1% |

The testing identified limitations in comparing averages of two populations (control and carbonated). In Tables 10 through 13 are presented and contain paired control/CO₂ sample tests. A paired test describes the production conditions in that four blocks were produced at a time on a single tray with two carbonated blocks produced alongside two uncarbonated (control) blocks. If a control block and a carbonated block from the same tray are tested and compared then the relative effect of the carbon dioxide treatment can be considered in another way.

In Table 10 and 11 paired strength results are presented for blocks made with a normal mix design and steam cured at 45° C. Tables 12 and 13 present paired strength results for blocks made with a lean mix design and stream cured at 45° C.

In Table 10 it can be seen, regarding strengths at 24 hours, that normal mix design blocks carbonated with 150 g of CO₂ for 15 seconds prior to steam curing were 4.5% weaker, 18.3% stronger and 11.5% stronger than the uncarbonated sample taken from the same tray. The average strength improvement of the carbonated over the control is seen to be 8.4%.

In Table 11 it can be seen, regarding strengths at 7 days, that normal mix design blocks carbonated with 150 g of CO₂ for 15 seconds prior to steam curing were 8.3% stronger, 4.5% stronger and 4.1% stronger than the uncarbonated sample taken from the same tray. The average strength improvement of the carbonated over the control is seen to be 5.7%.

In Table 12 it can be seen, regarding strengths at 24 hours, that lean mix design blocks carbonated with 150 g of CO₂ for 15 seconds prior to steam curing were 8.4% stronger, 3.5% stronger and 9.9% stronger than the uncarbonated sample taken from the same tray. The average strength improvement of the carbonated over the control is seen to be 7.3%.

In Table 13 it can be seen, regarding strengths at 7 days, that lean mix design blocks carbonated with 150 g of CO₂ for 15 seconds prior to steam curing were 4.4% weaker, 2.7% stronger and 9.1% stronger than the uncarbonated sample taken from the same tray. The average strength improvement of the carbonated over the control is seen to be 2.5%.

TABLE 10
24 hour strength of paired control/CO₂ samples made with normal
mix design and cured at 45° C. (15 s, 150 g CO₂, 328 LPM).

| | |
|---|---|
| Peak Stress (MPa) | CO₂ vs Control |

| Tray ID | Control | CO₂ | Abs. Diff. | % diff |
|---|---|---|---|---|
| 401 | 13.2 | 12.6 | −0.6 | −4.5% |
| 402 | 11.7 | 13.9 | +2.1 | +18.3% |
| 403 | 12.3 | 13.7 | +1.4 | +11.5% |
| Average | | | | +8.4% |

TABLE 11
7 day strength of paired control/CO₂ samples made with normal
mix design and cured at 45° C. (15 s, 150 g CO₂, 328 LPM).

| | |
|---|---|
| Peak Stress (MPa) | CO₂ vs Control |

| Tray ID | Control | CO₂ | Abs. Diff. | % diff |
|---|---|---|---|---|
| 403 | 18.0 | 19.5 | +1.5 | +8.3% |
| 404 | 20.1 | 21.0 | +0.9 | +4.5% |
| 405 | 18.8 | 19.6 | +0.8 | +4.1% |
| Average | | | | +5.7% |

TABLE 12
24 hour strength of paired control/CO₂ samples made with lean
mix design and cured at 45° C. (15 s, 150 g CO₂, 328 LPM).

| | |
|---|---|
| Peak Stress (MPa) | CO₂ vs Control |

| Tray ID | Control | CO₂ | Abs. Diff. | % diff |
|---|---|---|---|---|
| 425 | 11.4 | 12.4 | +1.0 | +8.4% |
| 426 | 10.8 | 11.2 | +0.4 | +3.5% |
| 427 | 10.8 | 11.9 | +1.1 | +9.9% |
| Average | | | | +7.3% |

TABLE 13
7 day strength of paired control/CO₂ samples made with lean
mix design and cured at 45° C. (15 s, 150 g CO₂, 328 LPM).

| | |
|---|---|
| Peak Stress (MPa) | CO₂ vs Control |

| Tray ID | Control | CO₂ | Abs. Diff. | % diff |
|---|---|---|---|---|
| 425 | 16.2 | 15.5 | −0.7 | −4.4% |
| 426 | 16.8 | 17.2 | +0.5 | +2.7% |
| 427 | 17.4 | 19.0 | +1.6 | +9.1% |
| Average | | | | +2.5% |

Concrete was carbonated with gas durations that were 7 seconds and less in order to minimize changes to typical production sequences and timings. Strength development was assessed. The standard concrete mix for this work included 125 kg of Portland cement, 15 kg of fly ash, 1184 kg of sand, 550 kg of stone and 250 mL of an admixture, Rheomix 750s. Approximately 40 L of water was added, but the exact amount was adjusted to make a dry mix that does not pour or flow, but is self supporting after compaction. The quantities in the mix design make a 0.688 cubic metre batch.

Additional mixes were tested that involved lowering the content of the binder (cement and fly ash) in the mix. Reductions of 5% and 7.5% were assessed. The cement was reduced from 125 kg to 119 kg to achieve a 5% reduction and to 116 kg to reach 7.5%.

In Table 14 it is shown the results of a regular mix concrete carbonated for 7 seconds with 65 g of CO₂ at 420 LPM. Steam curing was at 45° C. From Table 14 it can be seen that the brief carbon dioxide exposure had resulted in a small strength benefit realized at 7 and 28 days. A 7 second carbonation treatment too place entirely within the formation and compaction of the concrete block with no extension in the production time required.

TABLE 14
24 hour strength of paired control/CO₂ samples made with normal
mix design and cured at 45° C. (15 s, 150 g CO₂, 328 LPM).

| | | Mix 61 Control | | | Mix 61 CO₂ | | |
|---|---|---|---|---|---|---|---|
| | | 24 | 7 | 28 | 24 | 7 | 28 |
| Metric | Unit | h | d | d | h | d | d |
| Strength - Avg | MPa | 9.2 | 15.9 | 19.2 | 8.4 | 17.0 | 20.2 |
| Strength - Std | MPa | 0.9 | 0.6 | 0.5 | 1.1 | 2.7 | 0.8 |
| Dev | | | | | | | |
| Strength - Sample | MPa | 0.8 | 0.4 | 0.3 | 1.2 | 7.1 | 0.7 |
| Variance | | | | | | | |
| Strength - # of | # | 3 | 3 | 7 | 3 | 3 | 7 |
| Samples | | | | | | | |
| Strength Benefit | % | — | — | — | −8.7% | +7.0% | +5.4% |

| | | | |
|---|---|---|---|
| CO₂ Flow | LPM | — | 420 |
| CO₂ Dose | g | — | 65 |
| CO₂ Time | s | — | 7 |

In Table 15 the results are shown for a mix design with 5% less cement than a normal mix design and curing at 55° C. Table 15 shows that a carbonation treatment offered strength benefits at 7 days and 28 days. No benefit was seen at 24 hours but the strength development was such that the average carbonated block was 10.1% stronger at 7 days and 7.4% stronger at 28 days.

TABLE 15
Strength development of control/CO₂ samples made with
5% reduced cement mix design and cured at 55° C.

| | | Mix 62 Control | | | Mix 62 CO₂ | | |
|---|---|---|---|---|---|---|---|
| | | 24 | 7 | 28 | 24 | 7 | 28 |
| Metric | Unit | h | d | d | h | d | d |
| Strength - Avg | MPa | 9.2 | 14.6 | 18.6 | 9.0 | 16.1 | 20.0 |
| Strength - Std | MPa | 0.9 | 0.5 | 0.8 | 0.7 | 0.2 | 1.2 |
| Dev | | | | | | | |
| Strength - Sample | MPa | 0.8 | 0.2 | 0.6 | 0.5 | 0.0 | 1.4 |
| Variance | | | | | | | |
| Strength - # of | # | 3 | 3 | 7 | 2 | 3 | 7 |
| Samples | | | | | | | |
| Strength Benefit | % | — | — | — | −1.6% | +10.1% | +7.4% |

| | | | |
|---|---|---|---|
| CO₂ Flow | LPM | — | 420 |
| CO₂ Dose | g | — | 65 |
| CO₂ Time | s | — | 7 |

In Tables 16 through 18 it is shown the results for carbonating a regular mix design cured at 55° C. The carbonation treatment varied but was less than 6 seconds.

Table 16 shows that the carbonation treatment increased the strength of the concrete at 24 hours. A greater benefit was suggested if the dose and/or flow of gas was lower.

Table 17 shows that the carbonation treatment increased the strength of the concrete at 7 days. A greater benefit (7.2% improvement versus 5.1% improvement) was suggested if the dose and/or flow of gas was lower (50 g at 350 LPM rather than 68 g at 450 LPM).

Table 18 shows that the carbonation treatment increased the strength of the concrete at 28 days. A larger increase was found for the lower of two doses/gas flows. It was shown that the benefits of 50 g of CO₂ in 6 seconds (19.9% improvement) was greater than when the same amount of gas was delivered in 3 seconds (15.9%).

TABLE 16
Strength at 24 hours of control and CO₂ samples
made with regular mix design and cured at 55° C.

| | | Batch | | |
|---|---|---|---|---|
| Metric | Unit | Control | 81 | 82 |
| Strength - Avg | MPa | 10.3 | 11.0 | 10.8 |
| Strength - Std Dev | MPa | 0.6 | 0.8 | 0.4 |
| Strength - Sample | MPa | 0.4 | 0.58 | 0.13 |
| Variance | | | | |
| Strength - # of | # | 3 | 3 | 3 |
| Samples | | | | |
| Strength Benefit | % | — | +7.2% | +5.1% |
| CO₂ Flow | LPM | — | 350 | 450 |
| CO₂ Dose | g | — | 50 | 68 |
| CO₂ Time | s | — | 6 | 6 |

TABLE 17
Strength at 7 days of control and CO₂ samples made
with regular mix design and cured at 55° C.

| | | Batch | | |
|---|---|---|---|---|
| Metric | Unit | Control | 81 | 82 |
| Strength - Avg | MPa | 14.3 | 17.5 | 16.5 |
| Strength - Std Dev | MPa | 0.1 | 0.5 | 0.9 |
| Strength - Sample | MPa | 0.0 | 0.23 | 0.83 |
| Variance | | | | |
| Strength - # of | # | 3 | 3 | 3 |
| Samples | | | | |
| Strength Benefit | % | — | +22.0% | +15.3% |
| CO₂ Flow | LPM | — | 350 | 450 |
| CO₂ Dose | g | — | 50 | 68 |
| CO₂ Time | s | — | 6 | 6 |

TABLE 18
Strength at 28 days of control and CO₂ samples
made with regular mix design and cured at 55° C.

| | | Batch | | | |
|---|---|---|---|---|---|
| Metric | Unit | Control | 81 | 82 | 84 |
| Strength - Avg | MPa | 19.6 | 23.5 | 21.2 | 22.7 |
| Strength - Std Dev | MPa | 0.9 | 0.8 | 0.7 | 0.4 |
| Strength - Sample | MPa | 0.8 | 0.57 | 0.52 | 0.17 |
| Variance | | | | | |
| Strength - # of | # | 6 | 6 | 6 | 3 |
| Samples | | | | | |
| Strength Benefit | % | — | +19.9% | +8.0% | +15.9% |
| CO₂ Flow | LPM | — | 350 | 450 | 700 |
| CO₂ Dose | g | — | 50 | 68 | 50 |
| CO₂ Time | s | — | 6 | 6 | 3 |

Table 19 shows the results of concrete blocks produced with a mix design adjusted to have 7.5% less cement than normal. Blocks were cured at 55° C. and tested at 28 days. As seen in Table 19, a 10 second CO₂ treatment provided an average strength benefit of 14.7% at 28 days.

TABLE 19
Strength at 28 days of control and CO₂ samples made with
7.5% reduced cement mix design and cured at 55° C.

Batch 95

| Metric | Unit | Control | CO2 |
|---|---|---|---|
| Strength - Avg | MPa | 16.1 | 18.5 |
| Strength - Std Dev | MPa | 1.4 | 1.3 |
| Strength - Sample | MPa | 1.9 | 1.72 |
| Variance | | | |
| Strength - # of | # | 5 | 5 |
| Samples | | | |
| Strength Benefit | % | — | +14.7% |
| CO₂ Flow | LPM | — | 280 |
| CO₂ Dose | g | — | 68 |
| CO₂ Time | s | — | 10 |

While the above description provides examples of one or more processes or apparatuses, it will be appreciated that other processes or apparatuses may be within the scope of the accompanying claims.

1-26. (canceled)

27. A process, comprising:
providing a molding machine adapted to form a concrete article;
providing a mold within the molding machine, the mold comprising a plurality of perforations distributed across at least one molding surface; and
injecting carbon dioxide into concrete in the mold through the perforations.

28. The process of claim 27, wherein the concrete article is a substantially planar product, and the step of injecting comprises flowing the carbon dioxide downwardly through the perforations into the concrete.

29. The process of claim 28, wherein the step of injecting comprises flowing the carbon dioxide through at least one shoe element.

30. The process of claim 27, wherein the concrete article is a hollow product, and the step of injecting comprises flowing the carbon dioxide radially outwardly through the perforations into the concrete.

31. The process of claim 30, wherein the step of injecting comprises flowing the carbon dioxide through an inner mold wall.

32. An apparatus, comprising:
a mold shaped to form one or more surfaces of a concrete article, the mold comprising at least one molding surface comprising a plurality of perforations;
a conduit for gas to flow from an inlet to each of the perforations; and
a gas injection system adapted to inject carbon dioxide into concrete in the mold through the perforations while the concrete is in the mold.

33. The apparatus of claim 32, wherein the concrete article is a substantially planar product, and the mold comprises a base plate, a plurality of plates extending upwardly from the base plate, and a shoe element adapted to descend vertically into the mold to compact the concrete.

34. The apparatus of claim 33, wherein the perforations are formed in the shoe element so that the carbon dioxide flows downwardly into the concrete.

35. The apparatus of claim 32, wherein the concrete article is a hollow product, and the mold comprises inner and outer mold walls being generally cylindrical and generally concentrically arranged.

36. The apparatus of claim 35, wherein the perforations are formed in the inner mold wall so that the carbon dioxide flows radially outwardly into the concrete.

37. (canceled)

38. A process of accelerating the curing of concrete while of sequestering carbon dioxide in the concrete, comprising:
preparing the concrete comprising at least aggregate, a cementitious material, and water; and
injecting a stream of carbon dioxide-containing gas under pressure into a subsurface volume of the concrete at a plurality of locations adjoining the concrete.

39. The process of claim 38, wherein the step of injecting comprises injecting the carbon dioxide-containing gas through a plurality of apertures at the respective locations.

40. (canceled)

41. The process of claim 38, further comprising shaking the concrete while the stream of the carbon dioxide-containing gas is being injected into the subsurface volume.

42-43. (canceled)

44. The process of claim 27, wherein the carbon dioxide is injected at least in part while the mold is shaken.

45. The process of claim 27, wherein the carbon dioxide is injected for a period of time of about 60 seconds or less.

46. The apparatus of claim 32, wherein the perforations are distributed generally uniformly across most of the molding surface of the core form.

47. The apparatus of claim 32, wherein the core form comprises a bottom wall or gasket so that a generally sealed space is defined in the core form between the inlet and the perforations, at least when the core form is resting on a tray.

48. The apparatus of claim 32, wherein the gas injection system is adapted to inject carbon dioxide into concrete in the mold through the core form while the concrete is being shaken in the mold.

49. The apparatus of claim 32, wherein the gas injection system comprises at least one of a gas inlet manifold and a mass flow meter for delivering the carbon dioxide to the core assembly.

50. The apparatus of claim 32, further comprising a system for injecting a compressed gas through the perforations while concrete is not in the mold.
